(19) United States
(12) Patent Application Publication
(10) Pub. No.: US 2009/0319899 A1
(43) Pub. Date: Dec. 24, 2009

(54) USER INTERFACE, METHOD OF NAVIGATING CONTENT, APPARATUS FOR REPRODUCING CONTENT, AND STORAGE MEDIUM STORING THE METHOD

(75) Inventors: Ji-bum MOON, Seoul (KR); Young-mi KANG, Yongin-si (KR); Young-sun KIM, Suwon-si (KR); Yoon-hoe GU, Gwacheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO. LTD., Suwon-si (KR)

(21) Appl. No.: 12/388,530

(22) Filed: Feb. 19, 2009

(30) Foreign Application Priority Data
Jun. 24, 2008 (KR) 10-2008-0059790

(51) Int. Cl. G06F 3/048; G06F 7/06; G06F 17/30

(52) U.S. Cl. 715/716; 715/825; 715/817; 707/5; 707/E17.143; 707/E17.101; 707/E17.016

(57) ABSTRACT

A user interface for navigating content to be reproduced by selecting a filtering condition according to a user's preference on the basis of a playlist, a method of navigating content using the user interface, an apparatus for reproducing content, and a computer-readable storage medium having embodied thereon a program for executing the method are provided. The user interface navigates content using a method including displaying a first playlist on the basis of all reproducible pieces of content; receiving at least one content filtering condition; displaying a second playlist according to the received content filtering condition; and receiving a desired content select signal on the basis of the first playlist or the second playlist. Accordingly, the depth of a menu can be reduced, a playlist reflecting a user's preference can be created, and whether the content to be navigated exists can be more accurately perceived during content navigation.

### CROSS-REFERENCE TO RELATED PATENT APPLICATION

This application claims priority from Korean Patent Application No. 10-2008-0059790, filed on Jun. 24, 2008 in the Korean Intellectual Property Office, the disclosure of which is incorporated herein in its entirety by reference.

### BACKGROUND OF THE INVENTION

1. Field of the Invention

Apparatuses and methods consistent with the present invention relate to navigating content to be reproduced, and more particularly, to a user interface for navigating content, a method of navigating content using the user interface, an apparatus for reproducing content, and a computer-readable storage medium storing the method.

2. Description of the Related Art

As apparatuses for reproducing content that have a storage unit or can access a storage unit through a network have become increasingly used, various methods of efficiently navigating or searching for content stored in the storage unit have also been suggested.

Examples of apparatuses for reproducing content include a digital television, a high density digital recorder (HDDR), an MPEG layer-3 (MP3) player, a digital still camera, a mobile phone called a hand held phone or a cellular phone, a portable multimedia player, and an Internet protocol television (IPTV).

### SUMMARY OF THE INVENTION

Exemplary embodiments of the present invention provide a user interface for navigating content to be reproduced by selecting a filtering condition according to a user's preference on the basis of a playlist, a method of navigating content using the user interface, an apparatus for reproducing content, and a computer-readable storage medium having embodied thereon a program for executing the method.

The present invention is not limited to the aforementioned contents, and would be easily understood by one of ordinary skill in the art from the following description.

According to an aspect of the present invention, there is provided a user interface for navigating content using a method including displaying a first playlist on the basis of all reproducible pieces of content; receiving at least one content filtering condition; displaying a second playlist according to the received content filtering condition; and receiving a desired content select signal on the basis of the first playlist or the second playlist.

The method may further include receiving a content filtering condition add or change signal and displaying a third playlist according to the received content filtering condition add or change signal, wherein the receiving of the desired content select signal is performed on the basis of one of the first play list, the second playlist, and the third playlist.

The method may further include returning to a previous operation when a back signal is received in each operation.

The receiving of the at least one content filtering condition may be performed by using a filtering bar window displayed on the user interface, wherein the filtering bar window comprises at least one filtering item, and highlights a current selected filtering item.

The method may further include displaying at least one selectable content type information, wherein, when one content type is selected, the displaying of the first playlist comprises displaying the first playlist on the basis of all reproducible pieces of content included in the selected content type.

According to another aspect of the present invention, there is provided a method of navigating content, the method including displaying a first playlist on the basis of all reproducible pieces of content; receiving at least one content filtering condition; displaying a second playlist according to the received content filtering condition; and receiving a desired content select signal on the basis of the first playlist or the second playlist.

The method may further include receiving a content filtering condition add or change signal; and displaying a third playlist according to the received content filtering condition add or change signal, wherein the receiving of the desired content select signal is performed on the basis of one of the first playlist, the second playlist, and the third playlist.

The method may further include returning to a previous operation when a back signal is received in each operation.

The receiving of the at least one content filtering condition may be performed by using a filtering bar window displayed on a user interface, wherein the filtering bar window comprises at least one filtering item, and highlights a current selected filtering item.

The method may further include displaying at least one selectable content type information, wherein, when one content type is selected, the displaying of the first playlist comprises displaying the first playlist on the basis of all reproducible pieces of content included in the selected content type.

The receiving of the at least one content filtering condition may be performed by using a filter bar window displayed on a user interface, wherein the filtering bar window comprises at least one filtering item, and highlights a current selected filtering item.

According to another aspect of the present invention, there is provided an apparatus for reproducing content which has a storage unit storing content, or can access the storage unit through a network. The apparatus includes a user interface, when a first playlist is displayed on the basis of all reproducible pieces of content and then at least one content filtering condition is input, displaying a second playlist according to the input content filtering condition, and receiving a desired content select signal on the basis of the first playlist or the second playlist; a reproducing unit reproducing a desired content; and a control unit creating the first playlist or the second playlist according to a signal input through the user interface, providing the created first playlist or second playlist to the user interface, reading the desired content from the storage unit, and providing the read desired content to the reproducing unit.

According to another aspect of the present invention, there is provided a computer-readable storage medium having embodied thereon a program for executing a method of navigating content, wherein the method includes displaying a first playlist on the basis of all reproducible pieces of content; receiving at least one content filtering condition; displaying a second playlist according to the received content filtering condition; and receiving a desired content select signal on the basis of the first playlist or the second playlist.

The method may further include receiving a content filtering condition add or change signal; and displaying a third playlist according to the received content filtering condition add or change signal, wherein the receiving of the desired content select signal is performed on the basis of one of the first playlist, the second playlist, and the third playlist.

The method may further include returning to a previous operation when a back signal is received in each operation.

The receiving of the at least one content filtering condition may be performed by using a filtering bar window displayed on a user interface, wherein the filtering bar window comprises at least one filtering item, and highlights a current selected filtering item.

The method may further include displaying at least one selectable content type information, wherein, when one content type is selected, the displaying of the first playlist comprises displaying the first playlist on the basis of all reproducible pieces of content included in the selected content type.

The content may be managed by metadata in the user interface, the method, the apparatus, and the computer-readable storage medium.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for reproducing content according to an exemplary embodiment of the present invention;

FIG. 2 illustrates screens of a user interface of the apparatus of FIG. 1, according to an exemplary embodiment of the present invention;

FIG. 3 illustrates screens of the user interface of the apparatus of FIG. 1, according to another exemplary embodiment of the present invention;

FIG. 4 is a flowchart illustrating a method of navigating content according to an exemplary embodiment of the present invention; and

FIG. 5 is a flowchart illustrating a method of navigating content according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

Exemplary embodiments of the present invention can provide a user interface that can select a filtering condition for content navigation according to a user's preference on the basis of a playlist. Alternatively, exemplary embodiments of the present invention can provide a user interface that can select content to be reproduced by selecting, changing, or adding a filtering condition for content navigation by using a filtering bar provided along with a playlist to create a playlist reflecting a user's preference. Exemplary embodiments of the present invention can also provide a method of navigating content using the user interface, an apparatus for reproducing content, and a computer-readable storage medium having embodied thereon a program for executing the method.

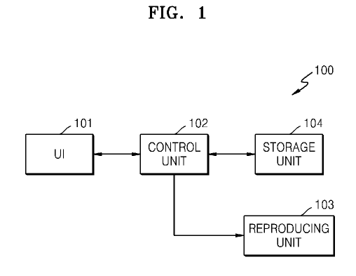

FIG. 1 is a block diagram of an apparatus 100 for reproducing content according to an exemplary embodiment of the present invention. Referring to FIG. 1, the apparatus 100 includes a user interface (UI) 101, a control unit 102, a reproducing unit 103, and a storage unit 104.

Although the apparatus 100 includes the storage unit 104 in FIG. 1, exemplary embodiments of the present invention are not limited thereto, and the apparatus 100 may access a storage unit (not shown) through a network. That is, the apparatus 100 may include only the UI 101, the control unit 102, and the reproducing unit 103 according to another exemplary embodiment of the present invention.

The apparatus 100 may be a digital television, a high density digital recorder (HDDR), an MPEG layer-3 (MP3) player, a digital still camera, a mobile phone called a hand held phone or a cellular phone, a portable multimedia player, or an Internet protocol television (IPTV) as set forth in the above description of the related art.

If the apparatus 100 is for reproducing one content type and content navigation is requested, the UI 101 displays a first playlist on the basis of all reproducible pieces of content. If content types can be classified into Video, Music, Pictures, FM Radio, Datacasts, Prime Pack, File Browser, Bluetooth, and so on, but the apparatus 100 is for reproducing only the content type “Music”, the UI 101 displays a first playlist on the basis of all reproducible pieces of music content.

All the reproducible pieces of music content are based on content stored in the storage unit 104. For example, when five pieces of music content are stored in the storage unit 104, the displayed first playlist includes information on the five pieces of music content. If the apparatus 100 may access the storage unit through the network, the first playlist is based on content stored in the storage unit.

After the first playlist is displayed, if at least one content filtering condition is input (or received), the UI 101 displays a second playlist according to the input content filtering condition.

The second playlist is created according to the content filtering condition and is based on the first playlist. That is, the second playlist includes content items satisfying the content filtering condition among content items included in the first playlist. Accordingly, the number of content items included in the second playlist is equal to or less than the number of content items included in the first playlist. The content items constituting the first playlist and the second playlist may be displayed in content titles.

If all of the reproducible pieces of content are associated with music, content filtering conditions may include Artist, Album, Genre, Rank, Social Music Network service (SMS), and Sorting Method. If at least one of the content filtering conditions is input, the UI 101 displays the second playlist.

The UI 101 may receive a desired content select signal from a user while displaying the first playlist, and may receive a desired content select signal from the user while displaying the second playlist.

If the apparatus 100 is a multimedia player that can reproduce a plurality of content types, such as all of the aforementioned content types, the UI 101 displays at least one selectable content type information before displaying the first playlist. The displayed content type information is based on the content stored in the storage unit 104. For example, if only video and music-related content is stored in the storage unit 104, the selectable content type information displayed by the UI 101 includes video information and music information.

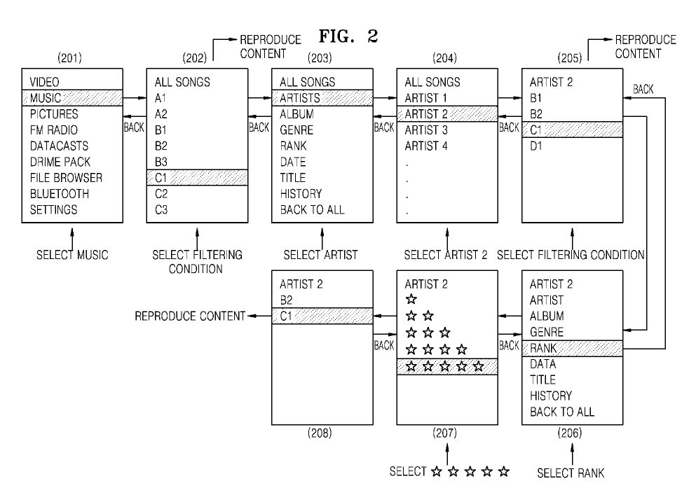

FIG. 2 illustrates screens of the UI 101 of the apparatus 100, according to an exemplary embodiment of the present invention. In FIG. 2, the apparatus 100 is a multimedia player and multiple content is stored in the storage unit 104.

Accordingly, if a content navigation request signal is received or content navigation is requested, the UI 101 displays a screen 201 including selectable content type information. If the user selects a content type “Music” on the screen 201, a screen 202 is displayed on the UI 101. The screen 202 corresponds to a first playlist. That is, the screen 202 corresponds to a playlist based on all reproducible pieces of music content in the apparatus 100. Content items of the screen 202 may be displayed in content titles. If the user selects an item “C1” as desired content on the screen 202 and transmits a desired content select signal to the UI 101, the UI 101 transmits the desired content select signal to the control unit 102 to reproduce the item “C1”.

However, if a “filtering condition select” request signal is received while the screen 202 is displayed, the UI 101 displays a screen 203 including selectable filtering condition information. If the user selects a filtering item “Artists” as a filtering condition on the screen 203 and transmits a filtering condition select signal to the UI 101, the UI 101 displays a screen 204 including a list of artists. The list of artists displayed on the screen 204 is based on the first playlist provided by the screen 202. That is, a list of artists related to the content type “Music” included in the first playlist provided on the screen 202 are displayed.

If the user selects an item “Artist 2” on the screen 204 and transmits a select signal to the UI 101, the UI 101 displays a screen 205 (corresponding to a second playlist) including only music content items of the item “Artist 2” in the first playlist displayed on the screen 202. If the user selects an item “C1” as desired content in the second playlist and transmits a desired content select signal to the UI 101, the UI 101 transmits the desired content select signal to the control unit 102 to reproduce the item “C1”.

However, if the user transmits a filtering condition select signal to the UI 101 while the screen 205 is displayed, the UI 101 displays a screen 206. The screen 206 is the same as the screen 203. If a filtering item “Rank” is selected on the screen 206, a screen 207 is displayed. If an item “⋆⋆⋆⋆⋆” is selected on the screen 207, it means that only pieces of music content having a rank of ⋆⋆⋆⋆⋆ should be detected from among all pieces of music content of the item “Artist 2” included in the first playlist. Accordingly, a third playlist corresponding to a screen 208 is a playlist obtained by adding the filtering condition of “⋆⋆⋆⋆⋆” to the filtering condition of “Artist 2”.

If the user transmits a back signal to the UI 101 when each screen is displayed on the UI 101, the UI 101 may return to a previous screen. For example, if the user transmits a back signal to the UI 101 by using a back function when the screen 208 is displayed, the screen 208 displayed on the UI 101 is changed to the screen 207. A filtering condition may be changed by using such a back function. For example, when the screen 207 is changed from the screen 208 due to the back function, the item “⋆⋆⋆⋆⋆” may be changed to an item “⋆⋆” by using the back function. In this case, a playlist satisfying the filtering condition of ⋆⋆ of the item “Artist 2” may be displayed on the UI 101. Also, when the screen 204 is changed from the screen 208 due to the back function, the item “Artist 2” may be changed to the item “Artist 1” by using the back function. In this case, a playlist satisfying the filtering condition of ⋆⋆⋆⋆⋆ of the item “Artist 1” may be displayed on the UI 101.

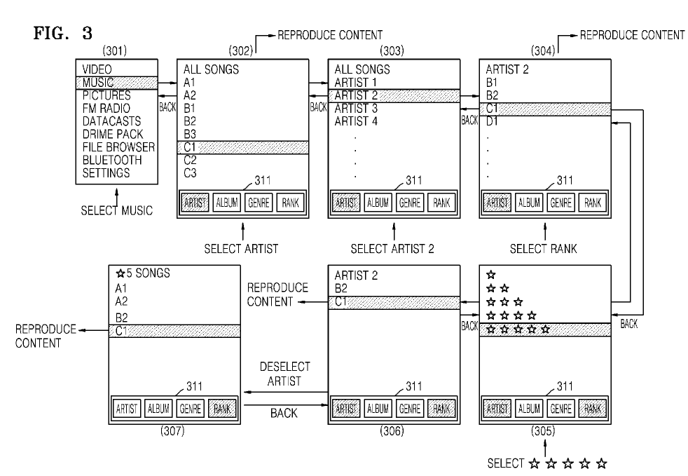

FIG. 3 illustrates screens of the UI 101 of the apparatus 100 of FIG. 1, according to another exemplary embodiment of the present invention. In FIG. 3, selectable filtering items may be displayed by using a filtering bar window 311, a filtering condition may be selected, and a current selected filtering item may be displayed.

That is, if a screen 301 including selectable content type information is displayed on the UI 101 and a content type “Music” is selected, a screen 302 is displayed on the UI 101. The screen 302 includes a filtering bar window 311 unlike the screen 202. The filtering bar window 311 includes selectable filtering items.

If a filtering item “Artist” is selected by using the filtering bar window 311 on the screen 302 displayed on the UI 101, a screen 303 is displayed on the UI 101. In this case, the selected filtering item “Artist” may be highlighted by displaying it in a different color or a thicker outline than other filtering items of the filtering bar window 311 of the screen 303. For example, it can be known that the filtering item “Artist”, which is highlighted by a different color or a thicker outline, has been selected from the other filtering items of the filtering bar window 311.

If an item “Artist 2” is selected on the screen 303, the UI 101 displays a screen 304. If a filtering item “Rank” is selected on the filtering bar window 311 of the screen 304, a screen 305 is displayed on the UI 101. If an item ⋆⋆⋆⋆⋆ is selected on the screen 305, a screen 306 is displayed on the UI 101. Accordingly, the screen 306 corresponds to a playlist satisfying the filtering condition of Artist 2 and the filtering condition of ⋆⋆⋆⋆⋆. If the filtering item “Artist” is deselected on the filtering bar window 311, a screen 307 is displayed on the UI 101. The screen 307 corresponds to a playlist satisfying the filtering condition of ⋆⋆⋆⋆⋆ on the playlist displayed on the screen 302.

Also, both the filtering items “Artist” and “Rank” selected by using the filtering bar window 311 of the screen 306 may be deselected and another filtering condition of “Album” and/or “Genre” may be selected. A content filtering condition may be added or changed in this way, and thus a playlist displayed on the UI 101 is changed. The changed playlist is based on the screen 202 in FIG. 2, or the screen 302 in FIG. 3.

Also, while the screens 302, 304, 306, and 307 are displayed on the UI 101, the UI 101 may receive a desired content select signal. Each screen may return to a previous screen by using a back function in FIG. 3 like that shown in FIG. 2.

The UI 101 may include a separate information input key or touch panel in order to input various select signals or information in FIGS. 2 and 3.

In FIGS. 2 and 3, the apparatus 100 is a multimedia player. However, the present invention is not limited thereto. For example, if the apparatus 100 is for reproducing only music and content navigation is requested, the UI 101 first displays the screen 202 of FIG. 2 or the screen 302 of FIG. 3. If the apparatus 100 is for reproducing video and content navigation is requested, the UI 101 first displays a playlist including all reproducible pieces of video content. All of the reproducible pieces of video content are based on the content stored in the storage unit 101, or the content stored in the storage unit which the apparatus 100 can access through the network.

The control unit 102 creates a playlist according to a signal input through the UI 101 and provides the created playlist to the UI 101. That is, the control unit 102 creates a playlist according to a filtering condition input through the UI 101 and provides the playlist to the UI 101. Also, the control unit 102 generates a list or information according to select information input through the UI 101 and provides the generated list or information to the UI 101. For example, the control unit generates information corresponding to each screen of FIG. 2 or 3 according to information input through the UI 101, and provides the generated information to the UI 101 so that each screen is displayed on the UI 101.

If information on desired content is received from the UI 101, the control unit 102 reads the desired content from the storage unit 104 and provides the read desired content to the reproducing unit 103. Accordingly, the reproducing unit 103 reproduces the desired content.

The storage unit 104 stores reproducible content and metadata for managing the content. The metadata may include content titles and selectable filtering condition information.

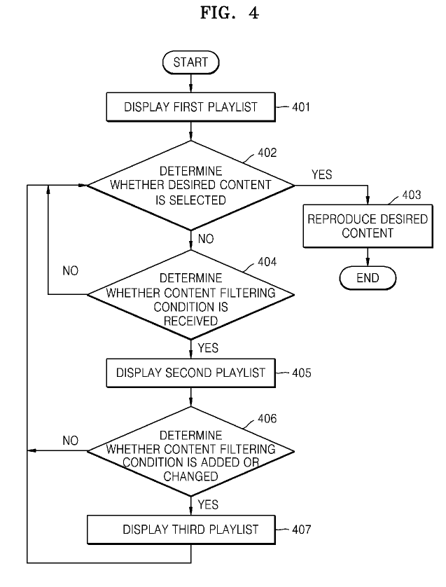

FIG. 4 is a flowchart illustrating a method of navigating content according to an exemplary embodiment of the present invention. In FIG. 4, an apparatus for reproducing content is for reproducing only one content type. The method of FIG. 4 will now be explained with reference to FIG. 1.

In operation 401, if content navigation is requested through the UI 101, the control unit 102 creates a first playlist on the basis of all reproducible pieces of content and displays the first playlist on the UI 101. The first playlist may be similar to the screen 202 of FIG. 2 or the screen 302 of FIG. 3.

In operation 402, the control unit 102 determines whether at least one desired content is selected through the UI 101 while the first playlist is displayed. If it is determined in operation 402 that the desired content is selected, the method proceeds to operation 403. In operation 403, the control unit 102 reads the selected desired content from the storage unit 104, and transmits the read desired content to the reproducing unit 103 to reproduce the desired content.

However, if it is determined in operation 402 that the desired content is not selected while the first playlist is displayed, the method proceeds to operation 404. In operation 404, the control unit 102 determines whether at least one content filtering condition is received.

If it is determined in operation 404 that the filtering condition is not received, the method returns to operation 402. However, if it is determined in operation 404 that the filtering condition is received, the method proceeds to operation 405. In operation 405, the control unit 102 displays a second playlist according to the received filtering condition. The second playlist may be similar to the screen 205 of FIG. 2 or the screen 304 of FIG. 3.

In operation 406, the control unit 102 determines whether at least one content filtering condition is added or changed through the UI 101. If it is determined in operation 406 that the content filtering condition is not added or changed, the method returns to operation 402 in which the control unit 102 determines whether at least one desired content is selected on the second playlist. If it is determined in operation 402 that the desired content is selected on the second playlist, the method proceeds to operation 403 in which the control unit 102 reproduces the selected desired content.

However, if it is determined in operation 406 that the content filtering condition is added or changed, the method proceeds to operation 407. In operation 407, the control unit 102 displays a third playlist according to the added or changed filtering condition. If at least one desired content is selected through the UI 101 while the third playlist is displayed, the control unit 102 controls the storage unit 104 and the reproducing unit 103 to reproduce the selected desired content.

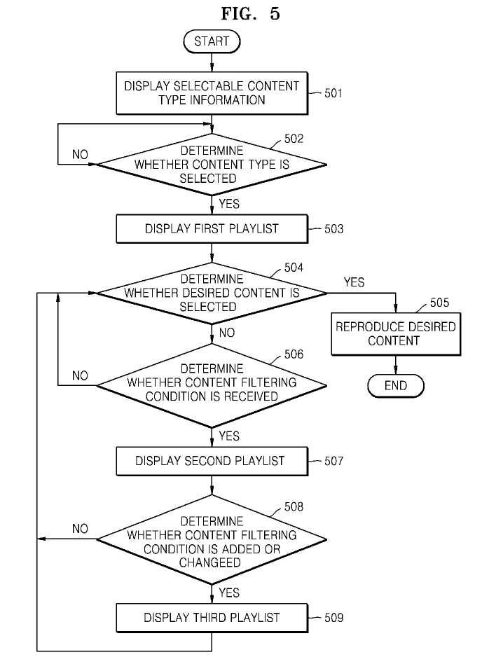

FIG. 5 is a flowchart illustrating a method of navigating content according to another exemplary embodiment of the present invention. In FIG. 5, an apparatus for reproducing content can reproduce multimedia content types. Accordingly, in operation 501, if content navigation is requested, the control unit 102 displays selectable content type information as shown on the screen 201 of FIG. 2 or the screen 301 of FIG. 3, unlike operation 401 of FIG. 4.

Once a content type is selected through the UI 101, the method of FIG. 5 is performed similarly to the method of FIG. 4. Accordingly, operations 503 through 509 of the method of FIG. 5 are the same as operations 401 through 407 of the method of FIG. 4.

Although the back function described in FIGS. 2 and 3 has not been described in FIGS. 4 and 5, the back function may be performed in each operation of the methods of FIGS. 4 and 5. Also, the filtering condition in FIGS. 4 and 5 may be received, added, or changed by using the filtering bar window described in FIG. 3. The content in FIGS. 4 and 5 may be managed by metadata.

As described above, since the apparatus for reproducing the content according to exemplary embodiments of the present invention selects a filtering condition for navigating content to be reproduced on the basis of a playlist, the depth of a menu can be reduced, a playlist reflecting a user's preference can be created, and whether the content to be navigated exists can be accurately perceived during content navigation.

A filtering condition of a playlist can be easily known and changed by using a filtering bar.

Effects of exemplary embodiments of the present invention are not limited to the aforementioned effects, and other effects would be easily understood by one of ordinary skill in the art from the attached claims.

The present invention may be embodied as computer-readable codes on a computer-readable recording medium. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, and optical data storage devices. The computer-readable recording medium can be dispersively installed in a computer system connected to a network, and stored and executed as a computer-readable code in a distributed computing environment.

While the present invention has been particularly shown and described with reference to exemplary embodiments thereof using specific terms, the embodiments and terms have been used to explain the present invention and should not be construed as limiting the scope of the present invention defined by the claims. The exemplary embodiments should be considered in descriptive sense only and not for purposes of limitation. Therefore, the scope of the invention is defined not bye the detailed description of the invention but by the appended claims, and all differences within the scope will be construed as being included in the present invention.

What is claimed is:

1. A method of navigating content, the method comprising:
displaying a first playlist based on all reproducible pieces of content;
receiving at least one content filtering condition;
displaying a second playlist based on the received content filtering condition; and
receiving a desired content select signal based on the first playlist or the second playlist.

2. The method of claim 1, further comprising:
receiving a content filtering condition add or change signal; and
displaying a third playlist based on the received content filtering condition add or change signal,
wherein the receiving of the desired content select signal is performed based on one of the first playlist, the second playlist, and the third playlist.

3. The method of claim 1, further comprising returning to a previous operation if a back signal is received in a current operation.

4. The method of claim 1, wherein:
the receiving of the content filtering condition is performed by using a filtering bar window displayed on a user interface, and
the filtering bar window comprises at least one filtering item, and highlights a currently selected filtering item.

5. The method of claim 1, further comprising displaying at least one selectable content type information,
wherein, if a content type is selected, the displaying of the first playlist comprises displaying the first playlist based on all reproducible pieces of content included in the selected content type.

6. The method of claim 5, wherein:
the receiving of the content filtering condition is performed by using a filter bar window displayed on a user interface, and
the filtering bar window comprises at least one filtering item, and highlights a currently selected filtering item.

7. The method of claim 1, wherein content is managed by metadata.

8. An apparatus for reproducing content, the apparatus comprising:
a user interface which, if a first playlist is displayed based on all reproducible pieces of content and then at least one content filtering condition is input, displays a second playlist based on the input content filtering condition, and receives a desired content select signal based on the first playlist or the second playlist;
a reproducing unit which reproduces a desired content; and
a control unit which creates the first playlist or the second playlist based on a signal input through the user interface, provides the created first playlist or second playlist to the user interface, reads the desired content from the storage unit, and provides the read desired content to the reproducing unit.

9. A computer-readable storage medium having embodied thereon a program for executing a method of navigating content, wherein the method comprises:
displaying a first playlist based on all reproducible pieces of content;
receiving at least one content filtering condition;
displaying a second playlist based on the received content filtering condition; and
receiving a desired content select signal based on the first playlist or the second playlist.

10. The computer-readable storage medium of claim 9, wherein the method further comprises:
receiving a content filtering condition add or change signal; and
displaying a third playlist based on the received content filtering condition add or change signal,
wherein the receiving of the desired content select signal is performed based on one of the first playlist, the second playlist, and the third playlist.

11. The computer-readable storage medium of claim 9, wherein the method further comprises returning to a previous operation if a back signal is received in a current operation.

12. The computer-readable storage medium of claim 9, wherein:
the receiving of the content filtering condition is performed by using a filtering bar window displayed on a user interface, and
the filtering bar window comprises at least one filtering item, and highlights a currently selected filtering item.

13. The computer-readable storage medium of claim 9, wherein:
the method further comprises displaying at least one selectable content type information, and
if a content type is selected, the displaying of the first playlist comprises displaying the first playlist based on all reproducible pieces of content included in the selected content type.

14. The apparatus of claim 8, further comprising a storage unit which stores content.

15. The apparatus of claim 8, wherein the apparatus accesses a storage unit through a network.
